(19) United States
(12) Patent Application Publication
(10) Pub. No.: US 2023/0256913 A1
(43) Pub. Date: Aug. 17, 2023

(54) Movable Vehicle Roof Rack Device

(71) Applicants: Terry Manion, Lindsay, OK (US); Kara Manion, Lindsay, OK (US)

(72) Inventors: Terry Manion, Lindsay, OK (US); Kara Manion, Lindsay, OK (US)

(21) Appl. No.: 18/168,667

(22) Filed: Feb. 14, 2023

Related U.S. Application Data
(60) Provisional application No. 63/310,343, filed on Feb. 15, 2022.

(51) Int. Cl. B60R 9/042; B60R 9/048

(52) U.S. Cl. CPC B60R 9/042; B60R 9/048

(57) ABSTRACT

The present invention relates to a movable vehicle roof rack device that allows a user to easily load and unload cargo from a vehicle roof. A frame of the device can be attached to a roof of a vehicle and/or a vehicle roof cargo rack. Cargo can be secured to a base of the device via anchor points and a cargo strap (or another similar fastener). While loading and unloading the cargo from the base, the base can be articulated via a hinge, a roller, and a hydraulic strut such that a user can load and unload the cargo while on the ground instead of standing on the vehicle and loading and unloading cargo from the vehicle roof.

### CROSS-REFERENCE TO RELATED APPLICATION

The present application claims priority to, and the benefit of, U.S. Provisional Application No. 63/310,343, which was filed on Feb. 15, 2022, and is incorporated herein by reference in its entirety.

### FIELD OF THE INVENTION

The present invention relates generally to the field of vehicle cargo racks. More specifically, the present invention relates to a movable vehicle roof rack device. A frame of the device can be attached to a roof of a vehicle and/or a vehicle roof cargo rack. Cargo can be secured to a base of the device via anchor points and a cargo strap (or another similar fastener). While loading and unloading the cargo from the base, the base can be articulated via a hinge, a roller, and a hydraulic strut so that a user can load and unload the cargo while on the ground instead of standing on the vehicle loading and unloading cargo from the vehicle roof. Accordingly, the present disclosure makes specific reference thereto. Nonetheless, it is to be appreciated that aspects of the present invention are also equally applicable to other like applications, devices, and methods of manufacture.

### BACKGROUND

Vehicle roof racks are typically used to transport various cargo such as, but not limited to, kayaks, bicycles, containers, and more. Loading and unloading items onto a roof rack can be difficult for many individuals. This is because an individual is often required to climb on top of the vehicle to load items onto the roof rack. This process can be extremely difficult, time-consuming, and dangerous depending on the size/weight of the cargo and the strength and mobility of the individual loading the cargo.

Therefore, there exists a long-felt need in the art for an improved vehicle roof rack. There also exists a long-felt need in the art for a movable vehicle roof rack device that aids a user in loading and unloading cargo from a vehicle roof rack. More specifically, there exists a long-felt need in the art for a movable vehicle roof rack device that allows a user to load and unload cargo onto a vehicle roof rack without having to climb onto a vehicle. Further, there exists a long-felt need in the art for a movable vehicle roof rack device that allows a user to load and unload cargo onto a vehicle roof rack more efficiently and safely than existing vehicle roof racks, regardless of their strength and mobility.

The subject matter disclosed and claimed herein, in one embodiment thereof, comprises a movable vehicle roof rack device. The device is primarily comprised of a frame with at least one mounting structure and a base that attaches to the frame via at least one hinge, wherein the base can slide from a base frame via at least one roller and at least one hydraulic strut. The frame of the device can be attached to the roof of a vehicle and/or a vehicle roof cargo rack. Cargo can be secured to the base of the device via anchor points and a cargo strap (or other similar fastener). While loading and unloading the cargo from the base, the base can be articulated via the hinge, the roller, and the hydraulic strut such that a user can load and unload the cargo while on the ground, instead of standing on the vehicle and loading and unloading cargo from the vehicle roof.

In this manner, the movable vehicle roof rack device of the present invention accomplishes all the foregoing objectives and provides an improved vehicle roof rack that aids a user in loading and unloading cargo from a vehicle roof rack. To do so, the roller, hydraulic strut, and hinge allow the base to move without a user having to climb onto a vehicle. As a result, a user can load and unload cargo onto a vehicle roof rack more efficiently and safely than existing vehicle roof racks.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a movable vehicle roof rack device. The device is primarily comprised of a frame with at least one mounting structure and a base that attaches to the frame via at least one hinge, wherein the base can slide from a base frame via at least one roller and at least one hydraulic strut. The device is comprised of a frame that supports the base of the device. The frame is preferably comprised of at least one leg having at least one mounting structure that allows the leg to attach to the roof of a vehicle and/or a luggage rack positioned on the roof.

At least one base of the device has a base frame that attaches to the frame via at least one hinge. The hinge preferably allows the base to articulate up to 270 degrees relative to the frame. The base frame also attaches to the frame via at least one hydraulic strut. In addition, the base frame is comprised of at least one roller (or roller assembly). Both the arm and the roller allow the base and base frame to be pulled away (extended) and tilted from the frame. This allows any cargo stored on the base to be easily accessed without having to climb to the roof of the vehicle.

The device is also comprised of a method of using the device. First, the device is secured to a roof of a vehicle via the mounting structure. Then, a lever is used to disengage a locking mechanism to allow the base to move and tilt from the frame via at least one hinge, at least one roller, and/or at least one hydraulic strut. The base may articulate as much as 270 degrees relative to the frame to allow a user to fully access the base while standing beside the vehicle on the ground. Next, at least one piece of cargo can be secured to a rail or anchor point on the base via at least one cargo strap (or any similar fastener of the like). Then, the user can position the base back atop the frame by sliding and tilting the base using the roller, hinge, and/or arm and then manipulate the lever to engage the locking mechanism to prevent movement of the base from the frame during transport.

Accordingly, the movable vehicle roof rack device of the present invention is particularly advantageous as it provides an improved vehicle roof rack. The device aids a user in loading and unloading cargo from a vehicle roof rack without having to climb onto a vehicle. As a result, the device allows a user to load and unload cargo onto a vehicle roof rack more efficiently and safely than existing vehicle roof racks, regardless of their strength and mobility. In this manner, the movable vehicle roof rack device overcomes the limitations of existing vehicle roof racks known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a movable vehicle roof rack device of the present invention while attached to a vehicle roof in accordance with the disclosed architecture;

FIG. 2 illustrates a perspective view of one potential embodiment of a movable vehicle roof rack device of the present invention while attached to a vehicle roof and wherein the base is tilted in accordance with the disclosed architecture;

FIG. 3 illustrates a perspective view of one potential embodiment of a movable vehicle roof rack device of the present invention while attached to a vehicle roof and wherein the base is tilted and extended in accordance with the disclosed architecture;

FIG. 4 illustrates a perspective view of one potential embodiment of a movable vehicle roof rack device of the present invention while attached to a vehicle roof in accordance with the disclosed architecture;

FIG. 5 illustrates a perspective view of one potential embodiment of a movable vehicle roof rack device of the present invention while attached to a vehicle roof and wherein the base is tilted, extended, and carrying cargo in accordance with the disclosed architecture; and

FIG. 6 illustrates a flow chart of a method of using one potential embodiment of a movable vehicle roof rack device of the present invention in accordance with the disclosed architecture.

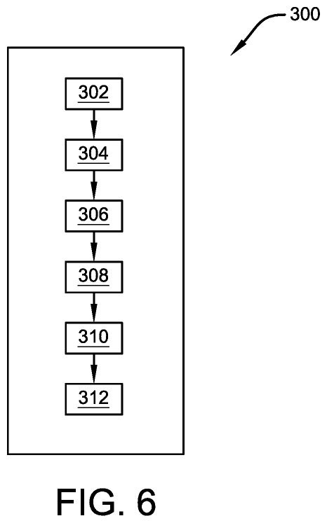

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved vehicle roof rack. There also exists a long-felt need in the art for a movable vehicle roof rack device that aids a user in loading and unloading cargo from a vehicle roof rack. More specifically, there exists a long-felt need in the art for a movable vehicle roof rack device that allows a user to load and unload cargo onto a vehicle roof rack without having to climb onto a vehicle. Further, there exists a long-felt need in the art for a movable vehicle roof rack device that allows a user to load and unload cargo onto a vehicle roof rack in a more efficient and safe manner than existing vehicle roof racks, regardless of their strength and mobility.

The present invention, in one exemplary embodiment, is comprised of a movable vehicle roof rack device primarily comprised of a frame with at least one mounting structure and a base that attaches to the frame via at least one hinge, wherein the base can slide from a base frame via at least one roller and at least one hydraulic strut. The device is comprised of a frame that supports the base of the device, wherein the frame is preferably comprised of at least one leg having at least one mounting structure. The mounting structure allows the leg to attach to the roof of a vehicle and/or a luggage rack positioned on the roof.

At least one base of the device has a base frame that attaches to the frame via at least one hinge. The hinge preferably allows the base to articulate up to 270 degrees relative to the frame. The base frame also attaches to the frame via at least one hydraulic strut. In addition, the base frame is comprised of at least one roller (or roller assembly). Both the arm and the roller allow the base and base frame to be pulled away (extended) and tilted from the frame to allow any cargo stored on the base to be easily accessed without having to climb to the roof of the vehicle.

The device is also comprised of a method of using the device. First, the device is secured to a roof of a vehicle via the mounting structure. Then, a lever is used to disengage a locking mechanism to allow the base to move and tilt from the frame via at least one hinge, at least one roller, and/or at least one hydraulic strut. The base may articulate as much as 270 degrees relative to the frame to allow a user to fully access the base while standing beside the vehicle on the ground. Next, at least one piece of cargo can be secured to a rail or anchor point on the base via at least one cargo strap (or any similar fastener of the like). Then, the user can position the base back atop the frame by sliding and tilting the base using the roller, hinge, and/or arm and then manipulating the lever to engage the locking mechanism to prevent movement of the base from the frame during transport.

Accordingly, the movable vehicle roof rack device of the present invention is particularly advantageous as it provides an improved vehicle roof rack. The device aids a user in loading and unloading cargo from a vehicle roof rack without having to climb onto a vehicle. As a result, the device allows a user to load and unload cargo onto a vehicle roof rack in a more efficient and safe manner than existing vehicle roof racks, regardless of their strength and mobility. In this manner, the movable vehicle roof rack device overcomes the limitations of existing vehicle roof racks known in the art.

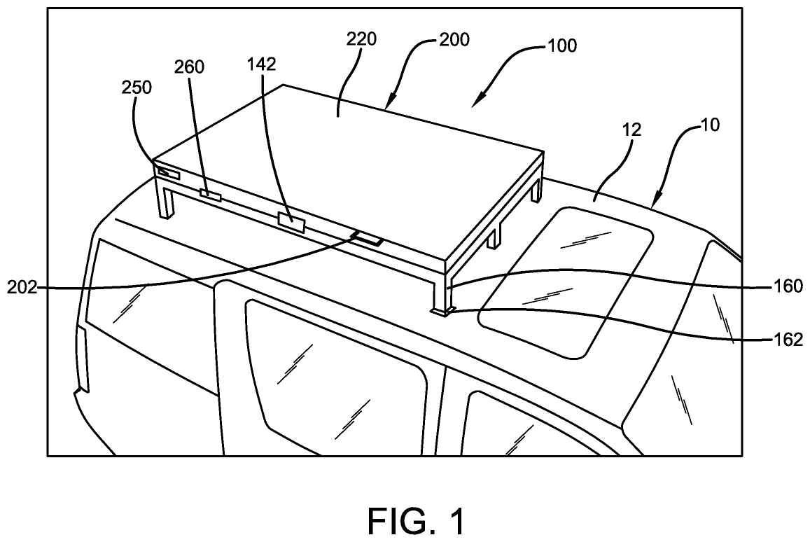

Referring initially to the drawings, FIG. 1 illustrates a perspective view of one potential embodiment of a movable vehicle roof rack device 100 of the present invention while attached to a vehicle roof in accordance with the disclosed architecture. The device 100 is primarily comprised of a frame 110 with at least one mounting structure 162 and a base 200 that attaches to the frame 110 via at least one hinge 142, wherein the base 200 can slide from a base frame 201 via at least one roller 140 and at least one hydraulic strut 150. All components of the device 100 are preferably comprised of a corrosion-resistant metal such as, but not limited to, stainless steel, aluminum, etc. The device 100 and/or components may also be made from a rigid, UV-resistant plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

The device 100 is comprised of a frame 110 that supports the base 200 of the device 100. The frame 110 is preferably square or rectangular in shape but may be any shape known in the art that fits atop a vehicle 10. The frame 110 is preferably comprised of at least one leg 160. The leg 160 is comprised of at least one mounting structure 162. The mounting structure 162 allows the leg 160 to attach to the roof 12 of a vehicle 10 and/or a luggage rack positioned on the roof 12. The mounting structure 162 may be any luggage-rack mounting structure known in the art. The structure 162 may also be any fastener or mounting system known in the art such as, but not limited to, magnet, screw, bolt, adhesive, etc. The frame 110 is preferably comprised of at least one vertical frame member 120 and at least one horizontal frame member 130. The frame members 120,130 preferably attach perpendicularly.

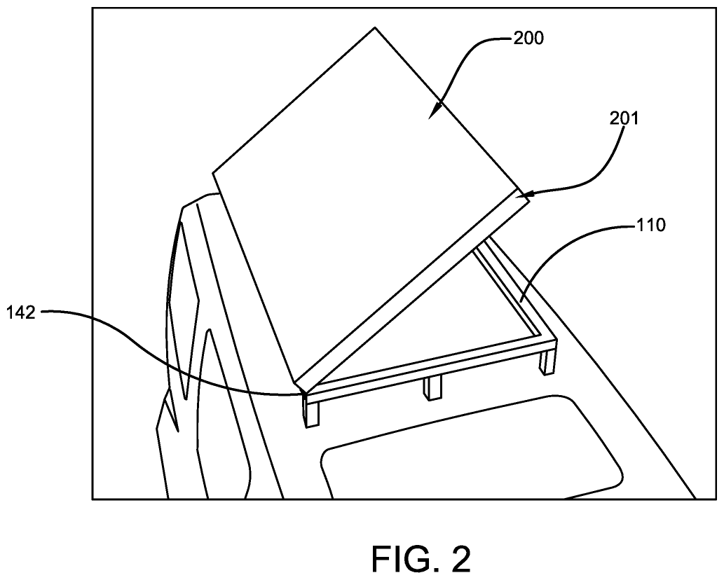

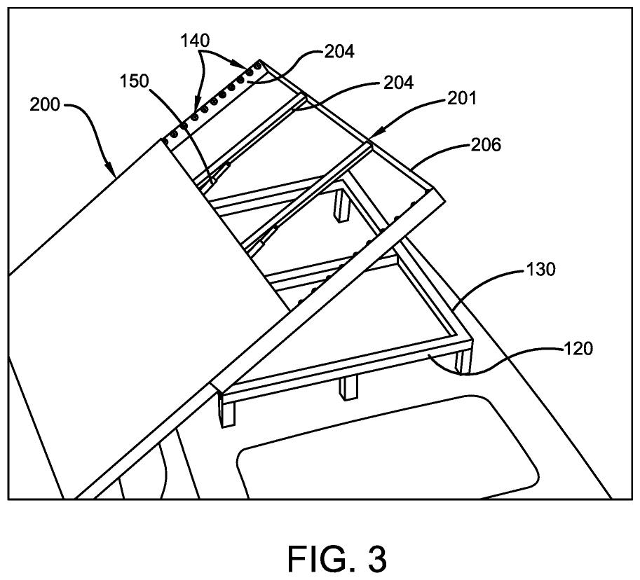

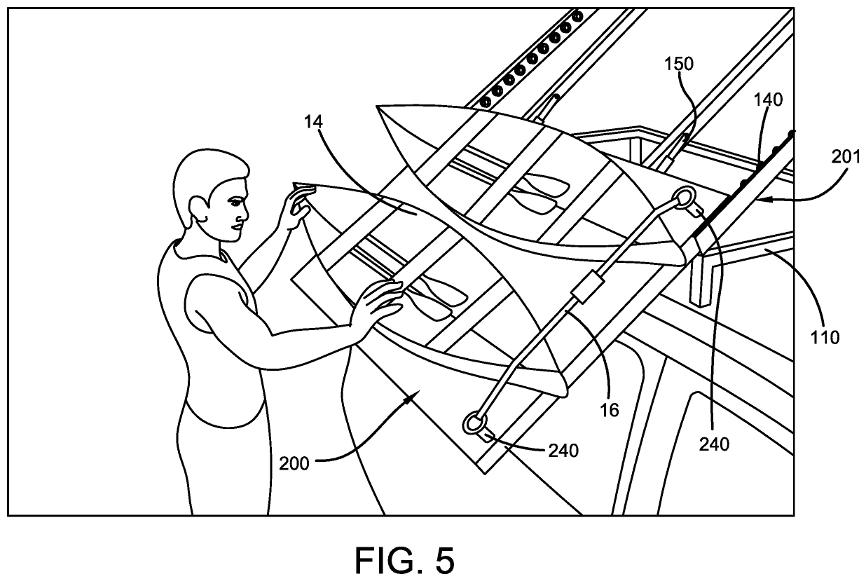

At least one base 200 has a frame 201 that attaches to the frame 110 via at least one hinge 142. The hinge 142 may be any type of hinge type known in the art but is preferably a locking hinge and/or a gas-assisted hinge. The hinge 142 preferably allows the base 200 to articulate up to 270 degrees relative to the frame 110, as seen in FIG. 2, FIG. 3, and FIG. 5. The base frame 201 has at least one vertical frame member 204 and at least one horizontal frame member 206.

The base frame 201 also attaches to the frame 110 via at least one hydraulic strut 150. In addition, the frame 201 is comprised of at least one roller 140 (or roller assembly). Both the arm 150 and the roller 140 allow the base 200 and base frame 201 to be pulled away (extended) and tilted from the frame 110, as seen in FIG. 3 and FIG. 5. This allows any cargo 14 stored on the base 200 to be easily accessed without having to climb to the roof 12 of the vehicle 10. More specifically, the hydraulic strut 150 ensures that the base 200 does not rapidly and uncontrollably move/tilt from the frame 110 during use, thereby preventing injury to a user. The base 200 may also be comprised of at least one handle 202 that aids a user in manipulating the base 200.

Motion of the base 200 from the frame 110 is preferably prevented by at least one locking mechanism 260. The locking mechanism 260 may be any locking mechanism known in the art that inhibits motion of the arm 150 and/or roller 140, and/or secures the base 200 to the frame 110 and/or base frame 201. This prevents the base 200 from moving while the vehicle 10 is in motion. The locking mechanism 260 can preferably be disengaged or engaged via at least one lever 250 or other similar actuating mechanism such as, but not limited to, a button. In one embodiment, the lever 250 is found on the handle 202.

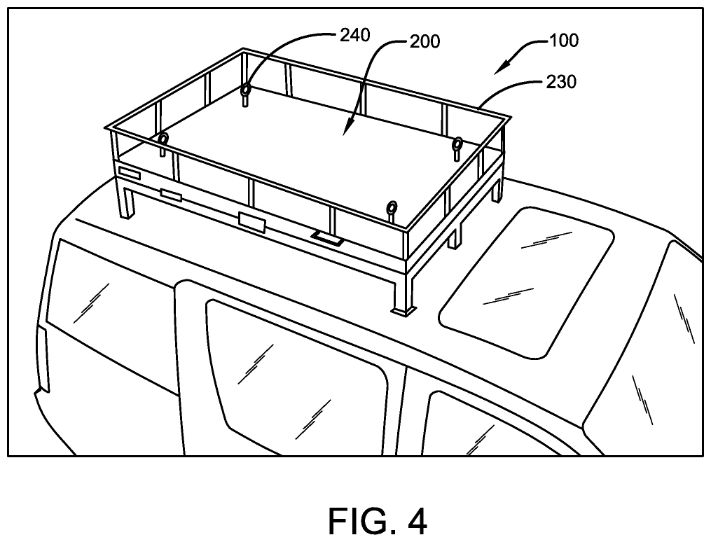

In a further embodiment, the top surface 220 of the base 200 is comprised of at least one guard rail 230, as seen in FIG. 4. The rail 230 serves as an anchor point for cargo straps or other similar securing fasteners of the like for cargo 14, and also prevents cargo 14 from sliding off the base 200 while the vehicle 10 is in motion. In another embodiment, the top surface 220 (or any other area of the base 200) may be comprised of at least one anchor point 240 to allow for cargo straps 16 or other tie-downs of the like to secure cargo 14 to the top surface 220. Said anchor point 240 may be a ring, an eyelet, or any other cargo-securing anchor point or style known in the art.

In one embodiment, the base 200 and/or frame 201 may be comprised of at least one leg 270. The leg 270 may be of a fixed length or may be adjustable in length in different embodiments, The leg 270 may articulate up to 360 degrees via at least one pivot point 272. The pivot point 272 may be any hinge, joint, or connection that allows the leg 270 to move. The leg 270 contacts the ground surface when cargo 14 is being loaded onto the base 200 to support and stabilize the weight of the base 200 and cargo 14. In another embodiment, the motion of the base 200 to/from the frame 110 may be assisted by at least one drill drive cable 274 or similar mechanisms that may assist or provide power to the hydraulic strut 150.

The device 100 is also comprised of a method 300 of using the device 100. First, the device 100 is secured to a roof 12 of a vehicle 10 via the mounting structure 162 [Step 302]. In this step, the device 100 may be secured directly to the roof 12 or may be secured to a cargo rack or any other structure found on the roof 12. Then, the lever 250 is used to disengage the locking mechanism 260 to allow the base 200 to move and tilt from the frame 110 via at least one hinge 142, at least one roller 140, and/or at least one hydraulic strut 150 [Step 304]. The base 200 may articulate as much as 270 degrees relative to the frame 110 to allow a user to fully access the base 200 while standing beside the vehicle 10 on the ground. Next, after manipulating the at least one piece of a cargo 14 can be secured to a rail 230 or anchor point 240 on the base 200 via at least one cargo strap 16 (or any similar fastener of the like), as seen in FIG. 5 [Step 306]. Then, the user can position the base 200 back atop the frame 110 by sliding and tilting the base using the roller 140, hinge 142, and/or arm 150 [Step 308]. A user can then manipulate the lever 250 to engage the locking mechanism 260 to prevent movement of the base 200 from the frame 110 during transport [Step 310]. Once a user has reached their destination, the lever 250 can be engaged again to disengage the locking mechanism 260 to allow the base 200 to be once again moved and tilted from the frame 110. This allows a user to remove the cargo 14 from the base 200 [Step 312].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “movable vehicle roof rack device” and “device” are interchangeable and refer to the movable vehicle roof rack device 100 of the present invention.

Notwithstanding the foregoing, the movable vehicle roof rack device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the movable vehicle roof rack device 100 as shown in the FIGS. are for illustrative purposes only, and that many other sizes and shapes of the movable vehicle roof rack device 100 are well within the scope of the present disclosure. Although the dimensions of the movable vehicle roof rack device 100 are important design parameters for user convenience, the movable vehicle roof rack device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A movable vehicle roof rack device comprising:
a first frame comprised of a leg and a mounting structure;
a base comprised of a second frame, a roller, a hydraulic strut and a guard rail;
a hinge; and
a locking mechanism.

2. The movable vehicle roof rack device of claim 1, wherein the hinge attaches the second frame of the base to the first frame.

3. The movable vehicle roof rack device of claim 1, wherein the base can articulate up to 270 degrees around the hinge.

4. The movable vehicle roof rack device of claim 1, wherein the mounting structure is comprised of a luggage rack mounting structure.

5. A movable vehicle roof rack device comprising:
a first frame comprised of a leg and a mounting structure;
a base;
a second frame;
a roller;
a hydraulic strut;
an anchor point;
a hinge; and
a locking mechanism.

6. The movable vehicle roof rack device of claim 5, wherein the locking mechanism inhibits the movement of the base from the first frame.

7. The movable vehicle roof rack device of claim 5, wherein the locking mechanism can be activated or deactivated by a button.

8. The movable vehicle roof rack device of claim 5, wherein the movable vehicle roof rack device is comprised of a UV-resistant plastic material.

9. A movable vehicle roof rack device comprising:
a first frame comprised of a leg and a mounting structure;
a base;
a second frame;
a roller;
a hydraulic strut;
an anchor point;
a handle;
a hinge;
a locking mechanism; and
a lever.

10. The movable vehicle roof rack device of claim 9, wherein the locking mechanism is activated and deactivated by the lever.

11. The movable vehicle roof rack device of claim 9, wherein the lever is positioned on the handle.

12. The movable vehicle roof rack device of claim 9, wherein the base can extend from the second frame.

13. The movable vehicle roof rack device of claim 12, wherein the base extends from the second frame via the roller.

14. The movable vehicle roof rack device of claim 9, wherein the hinge is comprised of a gas-assisted hinge.

15. The movable vehicle roof rack device of claim 9, wherein the anchor point is positioned on a top surface of the base.

16. The movable vehicle roof rack device of claim 9, wherein the guard rail is positioned on a top surface of the base.

17. The movable vehicle roof rack device of claim 9, wherein the mounting structure is comprised of a fastener.

18. The movable vehicle roof rack device of claim 9, wherein the roller attaches the base to the second frame.

19. The movable vehicle roof rack device of claim 9, wherein the hydraulic strut attaches to the second frame.

20. The movable vehicle roof rack device of claim 9, wherein the movable vehicle roof rack device is comprised of a corrosion-resistant metal material.
